(19) United States
(12) Patent Application Publication
(10) Pub. No.: US 2006/0271482 A1
(43) Pub. Date: Nov. 30, 2006

(54) Method, server and program for secure data exchange

(76) Inventors: Yoshitaka Bito, Kokubunji (JP); Masashi Haga, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/212,534

(22) Filed: Aug. 29, 2005

(30) Foreign Application Priority Data
May 27, 2005 (JP) 2005-156202

(51) Int. Cl. G06Q 99/00

(52) U.S. Cl. 705/50

(57) ABSTRACT

The invention provides a data exchange method, a data exchange management apparatus and a data exchange management program each capable of insuring high concealment and integrity and not requiring a data center. A data sending terminal generates a query for retrieving data, and make it up to a signed query by adding encryption information of the query (signature). When a data receiving terminal requests the data sending terminal to send the data, the data receiving terminal sends the signed query retrieved by a predetermined procedure. The data sending terminal verifies the signature of the signed queryand after verification proves successful, the data sending terminal sends the data retrieved by the query to the data receiving terminal.

### CLAIM OF PRIORITY

The present application claims priority from Japanese application JP 2005-156202 filed on May 27, 2005, the content of which is hereby incorporated by reference into this application.

### BACKGROUND OF THE INVENTION

1. Field of the Invention

This invention relates to a data exchange method, a data exchange management apparatus and a data exchange management program by an information system on a computer network.

2. Description of the Related Art

To improve both quality of medical cares and financial costs in the healthcare field, specialization and role assignment of healthcare institutions becomes essential in recent years. In other words, it has been expected politically and socially that clinics are assigned the role of gatekeepers, hub hospitals are assigned the role of medical sites which treat those severe diseases and emergency which cannot be made easily by the clinics, and special functional hospitals take charge of high-level medical cares such as transplantation of organs, respectively. It is also expected that some of the healthcare institutions specialize specific diseases or several specific fields.

As specialization of the healthcare institutions has thus been made from the aspect of improvement of quality of the medical care and the financial costs, it is continuity of medical care that becomes the problem. Without continuity of medical care, when one patient receives medical examinations in one healthcare institution, another healthcare institution cannot obtain the diagnostic condition of the previous healthcare institution and may possibly make an erroneous diagnosis for the patient. Even in the case of patient referral is sent from a clinic to a hub hospital and vice versa, discrepancy of remedial policy and lack of detailed medical data may occur due to limitation of referral information of the disease and its remedial method.

To simultaneously accomplish specialization of the healthcare institutions and continuity of the medical care, a system that shares or exchanges medical data among a plurality of healthcare institutions has been proposed to keep continuity. However, when the medical care is easily shared or exchanged, which means individual information flows on the network, the risk of wire trapping and falsification increases. In other words, the risk of concealment increases.

Needless to say, extremely high concealment is required for the medical information. Moreover, high concealment is required not only for the medical information but also for financial information, e.g. asset information, distribution information, e.g. purchase information, and resident information, e.g. dwelling places and family makeup.

The prior art technology about concealment of the network will be explained.

The prior art technology about a secret data exchange method that has been ordinarily employed includes a method that connects sites through VPN (Virtual Private Network). Keys are distributed to both sites and encryption and decryption are made by using the keys so that the content of the data cannot be tapped at an intermediate part of the path.

Patent Document 1, for example, proposes a method that sets up a common database of medical information in a hub hospital, connects the hub hospital and clinics through VPN and secures confidentiality of the data exchange. This document discloses a method for exchanging patient referrals by using a data center for concentratedly managing the data. Signature generated by a predetermined secret key (i.e. private key) is added to data sending between the medical linking server and a client terminal, and encryption is made with an encryption key. Incidentally, a public key cryptosystem and/or a common key cryptosystem are used for the key.

Patent Document 2 proposes a method that builds up information about medical cares and health in a data center, also builds up access control information recording approval/rejection of access for each user to the information on the basis of the information so built up, executes user verification on the basis of the access control information and discloses only the data to which access is permitted for the user.

Patent Document 3 discloses a method that makes direct communication between pier terminals used by those concerned in healthcare institutions in a distributed environment without using a data center for concentratedly managing data. A healthcare institution encryptes a patient referral and sends to another healthcare institution.

However, the prior art technologies described above involve the following problems.

The first problem is the risk of the lack of confidentiality that allows unauthorized users to tap the data on the communication path. Confidentiality is insured to a certain extent by the prior art technology for encrypting the points of the healthcare institutions but is not yet sufficient for handling high-level individual information. For example, the risk of exposure of these data increases when trespassing or hacking into the institutions occurs. There is also the case where a certain patient acquiring a patient referral from a healthcare institution A to a healthcare institution B does not visit the healthcare institution B, although the data of patient referral is sent from the healthcare institution A to the healthcare institution B or a data center. In such a case, unnecessary data is built up in the healthcare institution B or in the data center and the risk of exposure of the data becomes higher.

The second is the risk of the lack of integrity that decreases insuring the data is not falsified but is authentic data. For example, when the data is falsified at an intermediate point or unreliable data is sent from users, there is the possibility that the healthcare institution on the reception side may make diagnosis on the basis of the wrong data and exerts adverse influences on the patient. To prevent such a problem, it is necessary to insure that the data is authentic.

The third is the problem of cost and management labor required for constituting the data center as disclosed in JP-A-2000-331101 and JP-A-2003-67506, the data center is constituted and access control is set to each data. However, the data center construction requires a high operating cost such as installation cost of large quantities of storages and their maintenance cost.

JP-A-2004-295700 employs the distribution type network system in place of the data center and executes encryption. However, the data is directly sent to the receiving party and the first ad second risks of the lacks of confidentiality and integrity yet remain unsolved.

In view of the problems as the examples of the prior art technology described above, it is an object of the invention to provide a data exchange method, a data exchange management apparatus and a data exchange management program that have high concealment, insures integrity and eliminates the necessity for the data center.

To solve the problems described above, the invention provides a data exchange method for exchanging data among a plurality of terminals and a data exchange management server for managing the plurality of terminals, connected to the plurality of terminals through a network, wherein a terminal operating as a data sending terminal among the plurality of terminals executes a step for generating a query for extracting data and adds an encryption information for preventing falsification of the query; the data exchange management server executes a step of receiving and storing the query with the encryption information from the data sending terminal and a step of verifying the encryption information; and a terminal operating as a data receiving terminal among the plurality of terminals executes a step of receiving the query with the encryption information from the data exchange management server and a step of retrieving predetermined data from the data sending terminal on the basis of the query with the encryption information.

Other means will be described in later-appearing embodiments.

The data exchange method according to the invention can improve both confidentiality and integrity, because the data content is not transferred unless the authorized data query (i.e. signed query, the query with the encryption) is not sent. The invention can store data in a distribution environment by directly sending data from a sending institution to a receiving institution without using a data center.

### BRIEF DESCRIPTION OF THE DRAWINGS

FIG. 1 is an explanatory view for explaining an outline of a first embodiment of the invention;

FIG. 2 shows an example of a data structure of a query in the invention;

FIG. 3 is a sequence diagram for explaining a processing at the time of sending of a signed query in the first embodiment of the invention;

FIG. 4 is a sequence diagram for explaining a processing at the time of receiving of data in the first embodiment of the invention;

FIG. 5 shows an example of a screen of a data receiving terminal in the invention;

FIG. 6 is a flowchart of a data exchange management server at the time of reception of the query in the first embodiment of the invention;

FIG. 7 is a flowchart of the data exchange management server at the time of data request in the first embodiment of the invention;

FIG. 8 is an explanatory view for explaining an outline of a second embodiment of the invention;

FIG. 9 is a sequence diagram for explaining a processing at the time of sending of a signed query in the second embodiment of the invention;

FIG. 10 is a sequence diagram for explaining a processing at the time of data acquisition in the second embodiment of the invention;

FIG. 11 is an explanatory view for explaining an outline of a third embodiment of the invention;

FIG. 12 is a sequence diagram for explaining a processing at the time of sending of a signed query in the third embodiment of the invention;

FIG. 13 is a sequence diagram for explaining a processing at the time of data acquisition in the third embodiment of the invention;

FIG. 14 is a flowchart of a data exchange management server at the time of generation of a query control key in the third embodiment of the invention;

FIG. 15 is a flowchart of the data exchange management server for a data request in the third embodiment of the invention;

FIG. 16 shows an example of a data structure of a query in a fourth embodiment of the invention;

FIG. 17 is a sequence diagram for explaining a processing at the time of sending of a signed query in the fourth embodiment of the invention;

FIG. 18 is a sequence diagram for explaining a processing at the time of data acquisition in the fourth embodiment of the invention;

FIG. 19 is an explanatory view for explaining an outline of the fourth embodiment of the invention;

FIG. 20 shows an example of a network structure in the invention; and

FIG. 21 shows another example of the network structure in the invention.

### DESCRIPTION OF THE EMBODIMENTS

Embodiments of the invention will be hereinafter described with reference to the accompanying drawings.

### First Embodiment

In the first embodiment, a signed query generated by a data sending terminal (hereinafter called “sender” from time to time) is sent to and stored in a data exchange management server. The data exchange management server sends the signed query it stores to a data receiving terminal (hereinafter called “receiver” from time to time). The receiver requests data to the sender by using the signed query and retrieves the data. The above is a core part of the processing of this embodiment.

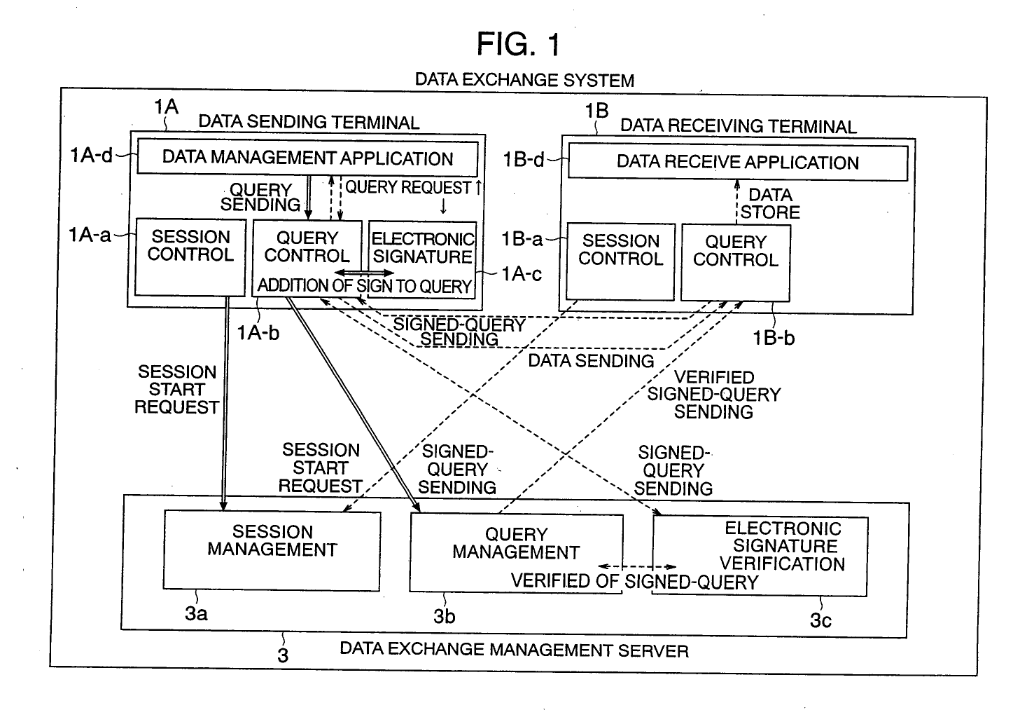

FIG. 1 is a view useful for explaining the outline of the data exchange system according to the first embodiment of the invention. In the data exchange method according to this embodiment, means for sending data from a data sending terminal 1A to a data receiving terminal 1B can be broadly divided into two processing. One is a series of sending processing (indicated by double line) that includes “sending of signed query” and the other is a series of receiving processing (indicated by dash line) that includes “request and retrieval of data” from the data receiving terminal 1B to the data sending terminal 1A by utilizing the data exchange management server 3.

Incidentally, the term “data” used in this specification represents those data which are sent from the data sending terminal to the data receiving terminal such as the electronic patient record system in the healthcare described already.

First, constituent elements shown in FIG. 1 will be explained.

The data sending terminal 1A is the terminal that sends the data. The functions provided to the data sending terminal 1A include a session control portion 1A-a, a query control portion 1A-b, an electronic signature portion 1A-c and a data management application portion 1A-d.

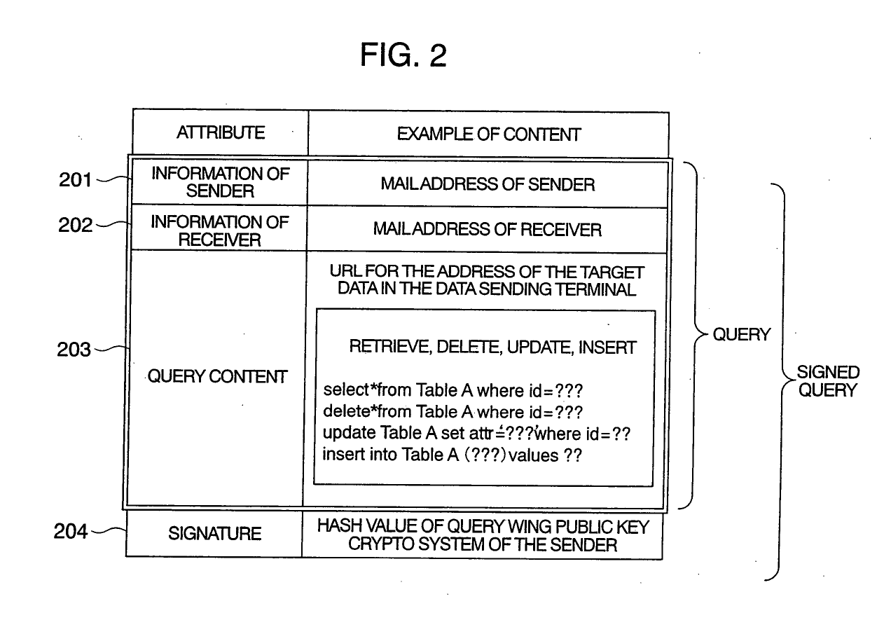

The session control portion 1A-a executes processing such as a session start request and a session end request of encryption communication paths (VPN) among the terminals that send and receive the data. Here, the term “session” represents those communication paths which are logically connected between the terminals (1A, 1B) or between the data exchange management server 3 and the terminals (1A, 1B). The query control portion 1A-b manages the query and sends the data. Incidentally, the query will be explained later with reference to FIG. 2. The electronic signature portion 1A-c adds a signature to the query. The data management application portion 1A-d is a business application for allowing the user of the sending terminal to use the present system and has the function of designating the data to be sent from the stored data.

The data receiving terminal 1B is the terminal on the data reception side. The functions provided to the data receiving terminal 1A include a session control portion 1B-a, a query control portion 1B-b and a data retrieval application portion 1B-d.

The session control portion 1B-a executes processing such as a session start request and a session end request of encryption communication paths (VPN) among the terminals (1A, 1B) that send and receive the data. The query control portion 1B-b manages the signed query received and receives the data. The data retrieval application 1B-d is a business application for allowing the user of the receiving terminal to use the present system and has the function of selecting the data to be received and looking up the reception data. Incidentally, in the operation of the present system in which the sending terminal and the receiving terminal are symmetric, sending and reception replace one another in some cases. Therefore, the data control application 1A-d and the data retrieval application 1B-d assume the same business application. However, they are called by different names for the ease of understanding because the object of use of the application is different between the sending side and the receiving side.

The data exchange management server 3 is the device that manages the query for sending and receiving the data. Functions provided to the data exchange management server 3 include a session management portion 3a, a query management portion 3b and an electronic signature verification portion 3c. The session management portion 3a receives and verifies the session start request from the data sending terminal 1A and the data receiving terminal 1B, sets the encryption communication path and establishes the session. The encryption communication path is accomplished by use of VPN, for example. The query management portion 3b stores the query sent from the data sending terminal 1A. The electronic signature verification portion 3c verifies the signed query sent.

The hardware construction of the terminals such as the data sending terminal 1A and the data receiving terminal 1B and the data exchange management server 3 in this embodiment includes CPU (Central Processing Unit), storage devices such as memories and hard disks, input devices such as keyboards and mouse, and output devices such as displays and communication devices for executing communication through a network.

The data exchange system of the invention (data sending terminal 1A, data receiving terminal 1B, data exchange management server 3) stores in advance a data exchange management program in the memories of the data sending terminal 1A, the data receiving terminal 1B and the data exchange management server 3, and the respective functions are established when CPU of the data sending terminal 1A, the data receiving terminal 1B and the data exchange management server 3 read and execute this program.

In other words, each of the session control portion 1A-a, the query management portion 1A-b, the electronic signature portion 1A-c and the data management application portion 1A-d operates in the data sending terminal 1A and each of the session control portion 1B-a, the query management portion 1B-b and the data retrieval application portion 1B-d operates in the data receiving terminal 1B. Each of the session management portion 3a, the query management portion 3b and the electronic signature portion 3c operates in the data exchange management server 3.

When user verification is an individual one (i.e. not an site verification) for the terminals such as the data sending terminal 1A and the data receiving terminal 1B, user verification is executed by using portable storage media such as an IC card. Incidentally, the portable medium and its reader need not be provided to the data exchange management server 3 but an encryption key necessary for verification needs be set instead by any means such as the use of an input device.

The query will be hereby examined.

The query is information that contains an address representing the data sending terminal 1A and URL (Uniform Resource Locator) representing the position of the data inside the data sending terminal 1A. FIG. 2 shows an example of the data structure of the query and the signature.

As shown in FIG. 2, the query includes information of sender 201, information of receiver 202 and query content 203. When signature 204 adds to this query, the query is called “signed query”.

A mail address, for example, is used for the information of sender 201 and information of receiver 202 but an IP address or a terminal name may be used as long as they are unique inside the network. The URL directly representing the location of the data of the sending terminal is described in the query content 203 and its form may be the one that can discriminate the sending terminal. For example, it may be described by a set of a database and SQL (Structural Query Language) that acquires the data from the database or a peculiar form of the data sending terminal 1A may be utilized, too, so that availability can be improved as much. When SQL is used, not only sending of the data but also deletion, updating and addition of the data can be safely made by this method. The query content portion 203 shown in FIG. 2 describes an example of SQL sentence used in this instance. When personal information is registered to the sending data, for example, the date receiving terminal 1B can be used for deleting the user information from the database, for changing the user address or for adding afresh family information. A questionnaire result can be added, too.

The signature 204 describes a hash value by a private encryption key of the sending terminal to the documents of the information of sender 201, information of receiver 202 and query content 203. As long as this signature 204 is put, a signature does not agree with this signature when the query content 203 is falsified. It is thus possible to know that the query content is falsified.

The same query content can be sent to a plurality of data receiving terminals 1B by describing a plurality of addresses of the data receiving terminal 1B on the information of receiver 202 of the query. In this way, the query can be generated efficiently compared to that the query is sent to a single receiver.

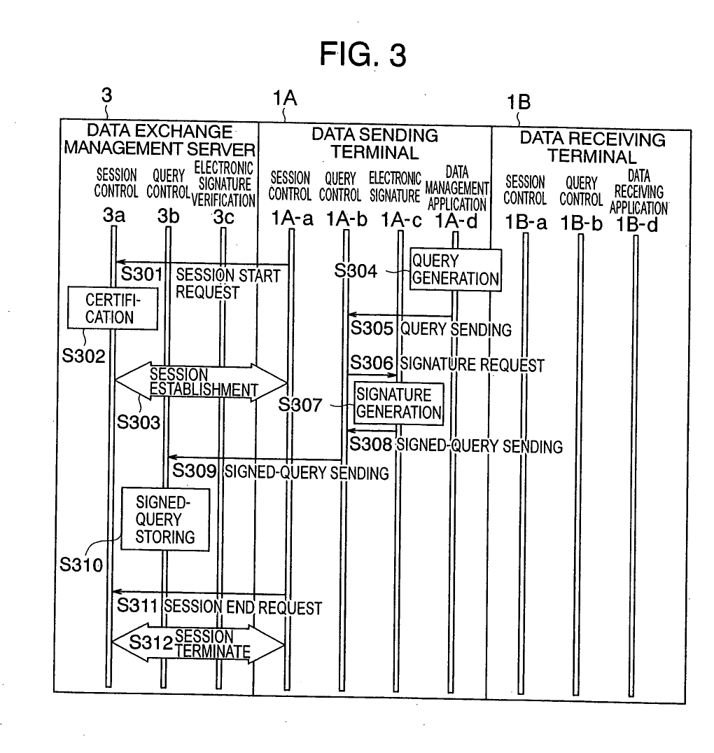

A series of processing inclusive of “signed query sending” when the data is sent (portion indicated by double line in FIG. 1) will be explained with reference to FIG. 3 and appropriately to FIG. 1.

When viewed from the user of the sending terminal, this processing corresponds to the part where the user logs in the application used for the business (here, data management application 1A-d) to select a certain data, and select the data receiving terminal 1B or data receiver, and the query generated corresponding to the data is sent to the data exchange management server 3.

First, the session control portion 1A-a of the data sending terminal 1A raises a session start request to the session control portion 3a of the data exchange management server 3 (S301). The session control portion 3a executes a certification procedure such as user certification (S302) and when certification proves successful, the session of the encryption communication path is established between the data sending terminal 1A and the data exchange management server 3 (S303). Consequently, concealment of the subsequent data exchange can be maintained.

Next the data management application 1A-d of the data sending terminal 1A generates the query of the data as the sending object selected by the user through an input device not shown (S304) and sends it to the query control portion 1A-b (S305). Receiving the query, the query control portion 1A-b requests signature of the query to the electronic signature portion 1A-c (S306) and the electronic signature portion 1A-c generates the signature and adds it to the query (i.e. signed query) (S307) and sends the signed query to the query control portion 1A-b. (S308). Incidentally, the sequence of the steps S301 to S303 and the steps S304 to S308 may be reversed. The query control portion 1A-b of the data sending terminal 1A thereafter sends the signed query to the query control portion 3b of the data exchange management server 3 (S309). The query control portion 3b stores the signed query it receives (S310).

The session control portion 1A-a of the data sending terminal 1A thereafter sends the session end request to the session control portion 3a of the data exchange management server 3 in accordance with the request from the user or with a predetermined time (S311) and the data exchange management server 3 finishes the session with the data sending terminal 1A (S312).

Incidentally, when a plurality of queries are sent, it is also possible to repeat the steps S309 to S310 to send a plurality of queries without starting or terminating the session one by one and then to terminate the session. Preferably, the public key cryptosystem and/or the common key cryptosystem is used for setting of the encryption communication path, and the public key cryptosystem is preferably used for the electronic signature.

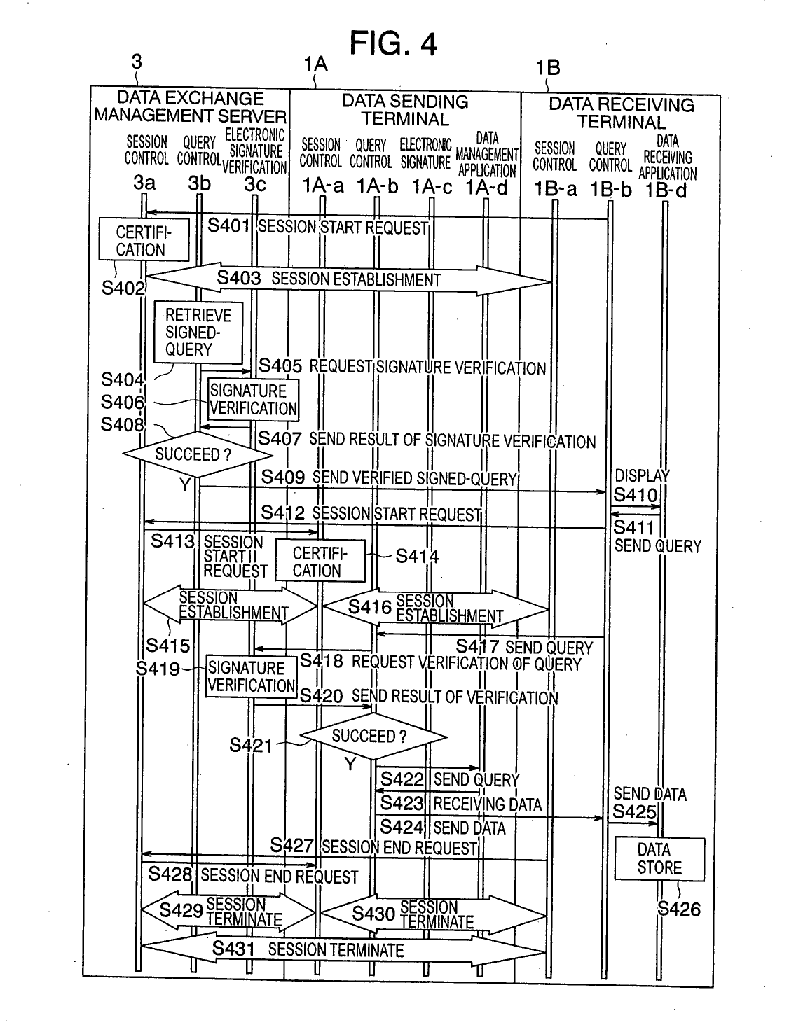

Next, a series of processing inclusive of “data request and retrieval” (portion indicated by dash line in FIG. 1) will be explained with reference to FIG. 4 and appropriately to FIG. 1. When viewed from the user of the receiving terminal, this processing corresponds to the part where the user logs in the application used for the business (here, data receive application 1B-d) to confirm whether or not the data addressed to the user exists from the list of the queries and the data receiving processing is executed when such data exists.

First, the session control portion 1B-a of the data receiving terminal 1B raises a session start request to the session control portion 3a of the data exchange management server 3 (S401). The session control portion 3a executes a certification procedure such as user certification (S402) and when certification proves successful, the session of the encryption communication path is established between the data receiving terminal 1B and the data exchange management server 3 (S403). Consequently, concealment of the subsequent data exchange can be maintained.

Next, the query control portion 3b of the data exchange management server 3 extracts the signed query corresponding to the data sent to the data receiving terminal 1B or to the user from the signed query stored in the step S310 in FIG. 3 (S404). The query control portion 3b requests verification of the signature of the signed query extracted to the electronic signature verification portion 3c (S405) and the electronic signature verification portion 3c verifies the signature (S406) and sends the verification result to the query control portion 3b (S407). Receiving the result, the query control portion 3b examines whether or not verification proves successful from the verification result of the signed query (S408) and when verification is successful (S408→Y), the query control portion 3b sends the verified signed query to the query control portion 1B-b of the data receiving terminal 1B (S409). Incidentally, verification of the signature in the steps S405 to S408 may be executed after the step S309 (before storage of signed query) in FIG. 3 instead of conducting it here. In this case, there is the advantage that only the query whose signature is verified is stored. On the other hand, when the step S408 does not prove successful, the processing of the step S409 is not executed and the data representing the failure is sent to the data receiving terminal 1B, whenever necessary (not shown).

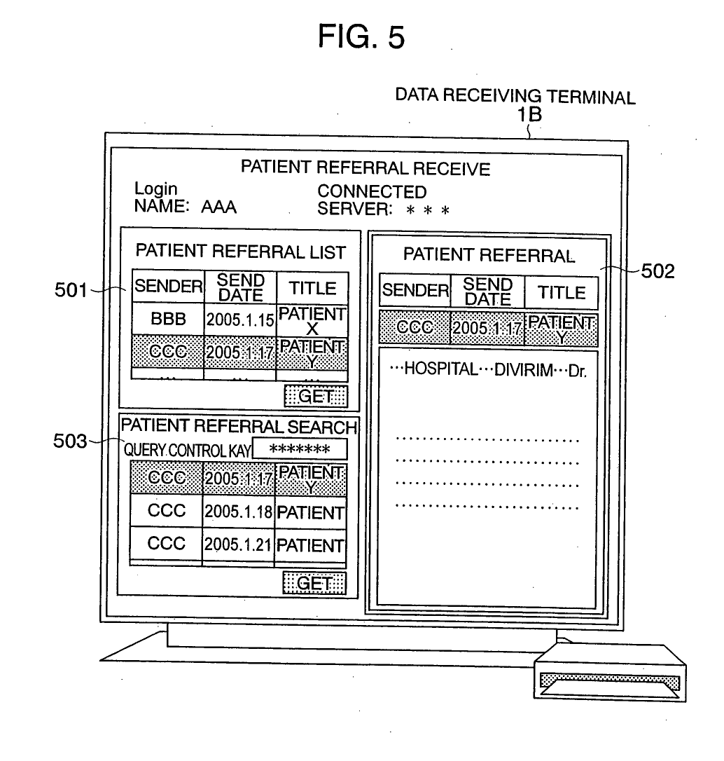

Next, the query control portion 1B-b of the data receiving terminal 1B sends the signed query to the data retrieval application 1B-d and the data retrieval application 1B-d displays the query on the display not shown in the drawing (S410). The user on the reception side selects the query from which the data is to be acquired from the list of the queries displayed, and the query is sent to the query control portion 1B-b through the input device (S411). The screen on the data reception side will be explained later with reference to FIG. 5.

The session control portion 1B-a of the data receiving terminal 1B sends the session start request to the session control portion 3a of the data exchange management server 3 (S412). This request contains information of the data sending terminal 1A that is necessary as the counter-part for receiving the data and the data exchange management server 3 sends the session start request to the session control portion 1A-a of the data sending terminal by this information (S413). The session control portion 1A-a executes the verification procedure such as user verification on the basis of the information received (S414). When verification proves successful, the session of the encryption communication path is established between the data sending terminal 1A and the data exchange management server 3 (S415). The session of the encryption communication path is established between the data receiving terminal 1B and the data sending terminal 1A, too (S416).

Subsequently, the query control portion 1B-b of the data receiving terminal 1B sends the signed query to the query control portion 1A-b of the data sending terminal 1A as the data query request (S417). The query control portion 1A-b of the data sending terminal 1A sends the signed query contained in the data query request received, as the signature verification request, to the electronic signature verification portion 3c of the data exchange management server 3 (S418). The electronic signature verification portion 3c verifies the signature of the signed query it receives (S419) and sends the verification result to the query control portion 1A-b (S420). Whether or not the query generated by the data sending terminal 1A is falsified at the data receiving terminal 1B is confirmed by executing this verification of the signature. Needless to say, concealment can be improved in this instance by confirming that the information of receiver 202 described in the query received (see FIG. 2) is the same as the information for identifying the data receiving terminal 1B to which access is made. The query control portion 1A-b examines whether or not verification of the signature proves successful on the basis of the verification result of the signed query (S421) and when verification is successful (S421→Y), the query control portion 1A-b refers the data to the data control application 1A-d by the verified signed query (S422), retrieves the data (S423) and sends the data so retrieved to the query control portion 1B-b of the data receiving terminal 1B (S424). The query control portion 1B-b of the data receiving terminal 1B sends the data to the data receive application 1B-d (S426). The data receive application 1B-d stores the data received (S426) and appropriately executes screen display, or the like. When the step S421 proves unsuccessful, on the other hand, the processing of the step S422 is not executed and the failure is reported to the data receiving terminal, whenever necessary (not shown in the drawing).

When the session of the encryption communication path is cut off in accordance with the request from the user or with the predetermined time, the session control portion 1B-a of the data receiving terminal 1B sends the session end query (S427). The session control portion 3a makes the session end query to the session control portion 1A-a of the data sending terminal 1A, too, on the basis of the data sending terminal information contained in the session end query (S428). Consequently, the session of the encryption communication paths among the three (data sending terminal 1A, data receiving terminal 1B and data exchange management serve 3) is terminated (S429 to S431).

FIG. 5 shows an example of screen shots of the data receiving terminal. The example describes the patient referral in the healthcare field but this also holds true of course of other data. The patient referral receive screen includes three screens, that is, a patient referral list 501, a patient referral 502 and a patient referral search 503.

The patient referral list 501 displays as a list of the referrals of the patients introduced from other hospitals to the hospital in which the data receiving terminal 1B is installed. When selection is made on this screen and the receive button is pushed, it is possible to look up the referral.

The patient referral 502 displays the content of the referrals that are selected by the patient referral list 501.

The patient referral search 503 displays the data coincident with the condition when the referral key is inputted. When selection is made on this screen and the receive button is pushed, it is possible to look up the referral. Incidentally, this patient referral search is for the case where the reference key is used as will be described in the third embodiment and is not always necessary for other embodiments.

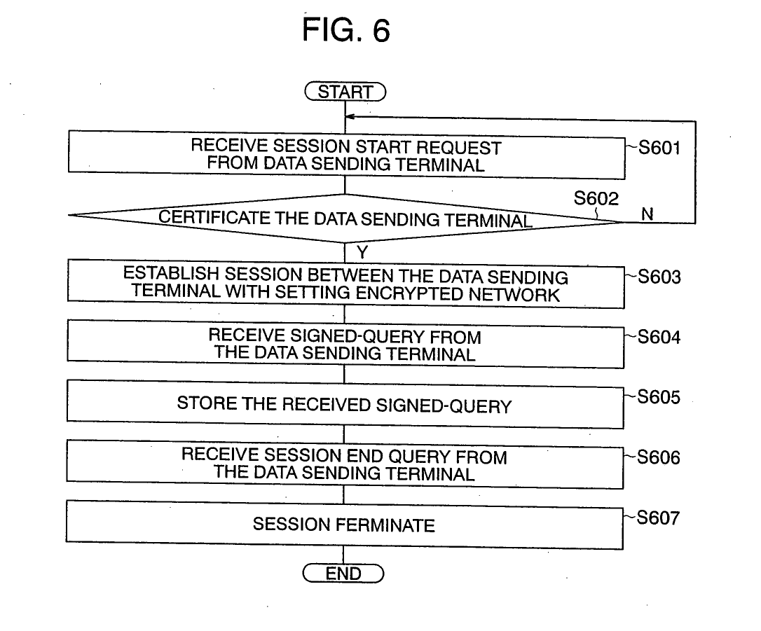

The processing of the data exchange management server 3 when the data sending terminal 1A sends the query to the data exchange management server 3 will be explained with reference to FIG. 6 and appropriately to FIG. 3.

First, the data exchange management server 3 receives the session start query from the data sending terminal 1A (S601, corresponding to S301 in FIG. 3) and executes certification such as user certification for the data sending terminal 1A (S602, corresponding to S302 in FIG. 3). When certification proves successful (S602→Y), the data exchange management server 3 sets up the encryption communication path between the data sending terminal 1A and itself (data exchange management server 3) to establish the session (S603: S303 in FIG. 3).

Next, the data exchange management server 3 receives the signed query from the data sending terminal 1A (S604: S309 in FIG. 3) and stores the signed query it receives (S605: S310 in FIG. 3).

The data exchange management server 3 thereafter receives the session end query from the data sending terminal 1A (S606: S311 in FIG. 3) and terminates the session between the data sending terminal 1A and itself (data exchange management server 3) (S607: S312 in FIG. 3).

When certification fails in the step S602, on the other hand (S602→N), the flow returns to the state before the step S601.

To send a plurality of queries, the steps S604 to S605 are repeated to send a plurality of queries without starting and terminating the session each time and then the session may be terminated.

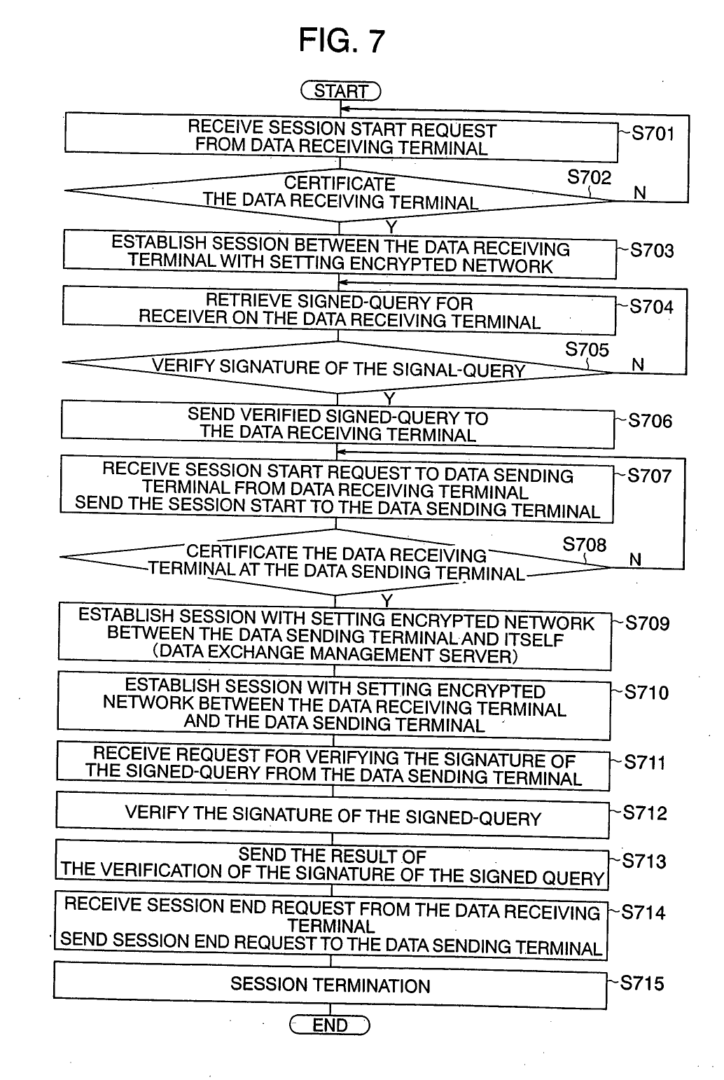

The processing of the data exchange management server 3 when the data receiving terminal 1B receives the query from the data sending terminal 1A will be explained with reference to FIG. 7 and appropriately to FIG. 4.

First, the data exchange management server 3 receives the session start query from the data receiving terminal 1B (S701, corresponding to S401 in FIG. 4) and executes certification such as user certification for the data receiving terminal 1B (S702, corresponding to S402 in FIG. 4). When certification proves successful (S702→Y), the data exchange management server 3 sets up the encryption communication path between the data receiving terminal 1B and itself (data exchange management server 3) to establish the session (S703: S403 in FIG. 4). On the other hand, when certification of the receiving terminal fails in the step S702 (S702→N), the flow returns to the state before the step S704.

Next, the data exchange management server 3 extracts the signed query corresponding to the data sent to the data receiving terminal 1B or to the user from the signed query from the signed query stored in the step S605 in FIG. 6 (S704: S404 in FIG. 4), and the signed query so extracted is verified (S705: S405 to S407 in FIG. 4). When this verification proves successful (S705→Y: S408 in FIG. 4), the data exchange management server 3 sends the verified signed query to the data receiving terminal 1B (S706: S409 in FIG. 4). On the other hand, when the verification result does not prove successful (S705→N), the flow returns to the state before the step S704.

The data exchange management server 3 receives the session start query from the data receiving terminal 1B and sends the session start query to the data sending terminal 1A on the basis of the data of the data sending terminal 1A contained in the session start query (S707: S412 to S413 in FIG. 4). When verification of the session start query sent proves successful (S708→Y) at the data sending terminal, the data exchange management server 3 sets up the encryption communication path between itself (data exchange management server 3)and the data sending terminal 1A and establishes the session (S709: S415 in FIG. 4). The session of the encryption communication path is established between the data receiving terminal 1B and the data sending terminal 1A, too (S710: S416 in FIG. 4). On the other hand, when verification of the receiving terminal fails in the step S702 (S708→N), the flow returns to the state before the step S707.

The data exchange management server 3 receives the verification request of the signature from the data sending terminal 1A (S711: S418 in FIG. 4) and executes verification (S712: S419 n FIG. 4). The data exchange management server 3 sends the verification result to the data sending terminal 1A (S713: S420 in FIG. 4).

Receiving the session end request from the data receiving terminal 1B, the data exchange management server 3 sends the session end request to the data sending terminal 1A on the basis of the data of the data sending terminal 1A contained in the session end request it receives (S714: S427 to 428 in FIG. 4), and the session of the encryption communication paths among the three (data receiving terminal 1B, data sending terminal 1A and data exchange management server 3) is terminated (S715: S429 to S431 in FIG. 4).

By the method described above, the data itself is not directly sent but the query for retrieving the data is sent. Therefore, the data is sent only when the request exists and the data is not sent unnecessarily to the outside. Because the query for receiving the data is encrypted and sent and is further signed, concealment can be improved. In other words, when the query is falsified, for example, the verification result of the signature proves unsuccessful and the data cannot be received. Consequently, authenticity of the data to be received can be improved. This is because the possibility of retrieving illegal data can be reduced by putting the signature.

In this system, the method of dynamically constituting the encryption communication path in accordance with the request from the client is shown. This means is effective for quickly securing the encryption communication paths only when necessary in the case where healthcare providers, drugstores, health checkup care centers, etc, dispersedly keep the data.

Next, a modified embodiment of the invention will be illustrated.

Turning back to FIG. 1, the data exchange management server 3 executes verification of the electronic signature for the signed query (steps S406 and S419 in FIG. 4 and steps S705 and S712 in FIG. 7) but this processing can be omitted. However, when the electronic signature has already been put to the resulting data such as the prescriptions and the referrals, authenticity can be secured by conducting verification after the data is received.

The processing for putting the signature to the query in the steps S306 to S308 shown in FIG. 3 can be conducted by the data exchange management server 3. In this case, authenticity of the data can be improved because so-called “impersonation” can be detected by collectively managing the logs to the signature on the server side.

The data exchange management server 3 may have the function of temporarily storing the data to be sent as one of its functions. When the query is received from the data sending terminal 1A (step S309 in FIG. 3 and step S604 in FIG. 6), the data exchange management server 3 temporarily stores the data simultaneously with the signed query. It becomes thus possible to respond to the data query request from the data receiving terminal 1B even when the data sending terminal 1A does not operate. In this case, concealment of the data drops but the possibility of harm due to the outflow of the data is believed lower than when the data center is constituted because only the data sent to the data exchange management server 3 is temporarily stored.

### Second Embodiment

The second embodiment is the form in which the data receiving terminal stores the signed query in place of the data exchange management server.

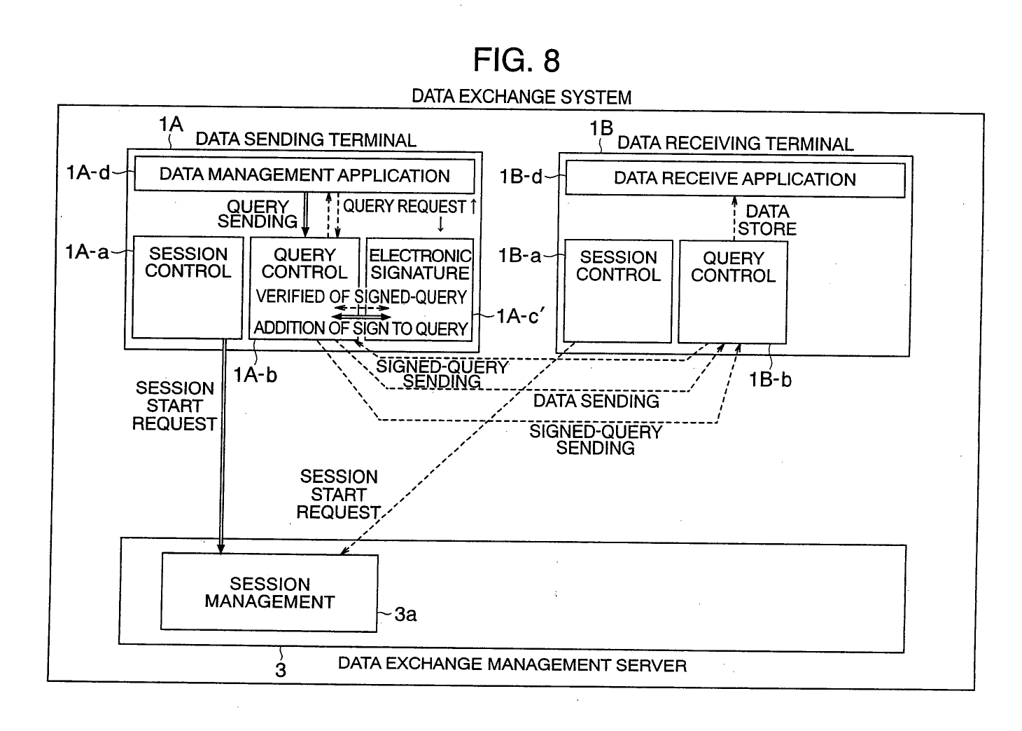

FIG. 8 is a view useful for explaining the outline of the data exchange system according to the second embodiment of the invention. The difference of this embodiment from the first embodiment resides in that the data exchange management server 3 executes only session management of the encryption communication path and the data sending/receiving terminals (1A, 1B) execute verification of the signature and storage of the query. Therefore, the query management portion 3b and the electronic signature verification portion 3c provided to the data exchange management server 3 in the first embodiment do not exist and the electronic signature verification portion 1A-c′ replaces the electronic signature portion 1A-c of the data sending terminal 1A. Their functions will be explained later in detail.

In the data exchange method of this embodiment, the means for sending the data from the data sending terminal 1A to the data receiving terminal 1B is broadly divided into two processing in the same way as in the first embodiment. One is a series of processing including “sending of signed query” from the data sending terminal 1A to the data receiving terminal 1B (indicated by double line) and the other is a series of processing including “data request and retrieval” from the data receiving terminal 1B to the data sending terminal 1A (indicated by dash line).

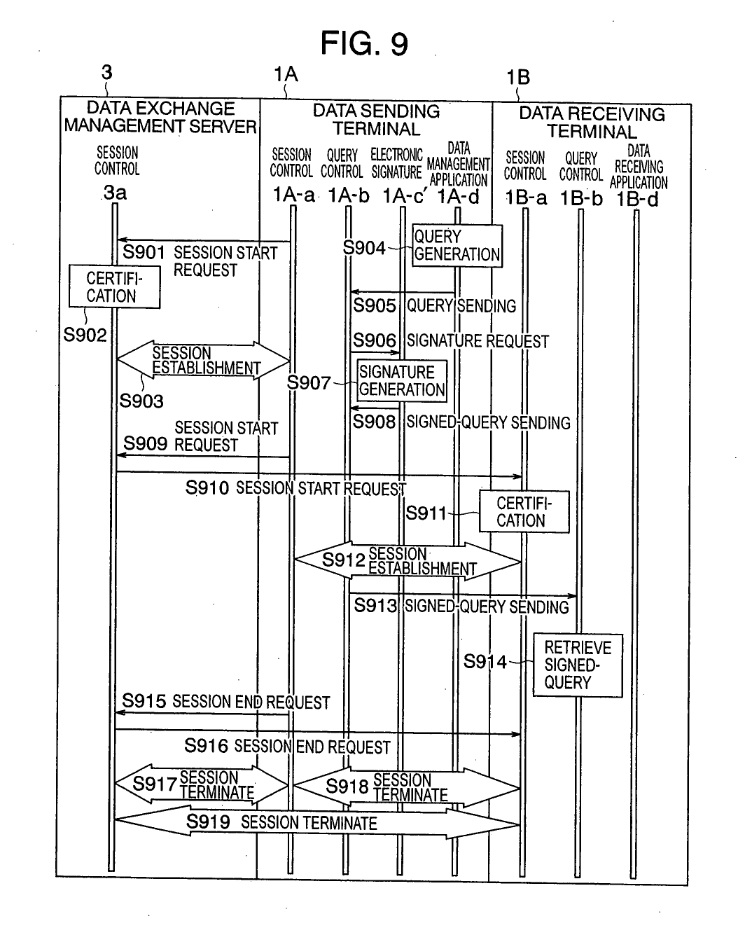

The great difference from the first embodiment is that the query is directly sent to the data receiving terminal. First, a series of processing including “sending of signed query” (portion indicated by double line in FIG. 8) will be explained with reference to FIG. 9 and appropriately to FIG. 8.

When viewed from the user of the sending terminal, this processing corresponds to the part where the user logs in the application used for the business (here, data management application 1A-d) to select a certain data and the data receiving terminal 1B, and the query generated corresponding to the selected data is sent to the receiving terminal.

Steps S901 to S908 in FIG. 9 are the same as steps S301 to S308 explained in the first embodiment and their explanation will be therefore omitted.

When the session is established by this processing between the data exchange management server 3 and the data sending terminal 1A, the session control portion 1A-a of the data sending terminal 1A subsequently makes the session start request with the data receiving terminal 1B to the session management portion 3a of the data exchange management server 3 (S909). The session management portion 3a of the data exchange management server 3 makes the session start request to the session control portion 1B-a of the data receiving terminal 1B on the basis of the information of the data receiving terminal 1B contained in the request received (S910). Receiving the request, the session control portion 1B-a executes the verification procedure such as user verification (S911). When this verification proves successful, the session of the encryption communication path is established between the data sending terminal 1A and the data receiving terminal 1B (S912). Consequently, concealment of the subsequent data exchange can be maintained.

The query control portion 1A-b of the data sending terminal 1A thereafter sends the signed query to the query control portion 1B-b of the data receiving terminal 1B (S913). The query control portion 1B-b stores the signed query received (S914).

The session control portion 1A-a of the data sending terminal 1A sends the session end query to the session control portion 3a of the data exchange management server 3 in accordance with the request from the user or with the predetermined time (S915). The session control portion 3a makes the session end query to the session control portion 1B-a of the data receiving terminal 1B on the basis of the data receiving terminal information contained in the session end query (S916). Consequently, the session among the three (data sending terminal 1A, data receiving terminal 1B and data exchange management serve 3) is terminated (S917 to S919).

To send a plurality of queries, the steps S913 to S914 are repeated to send a plurality of queries without starting and terminating the session each time, and then the session may then be terminated.

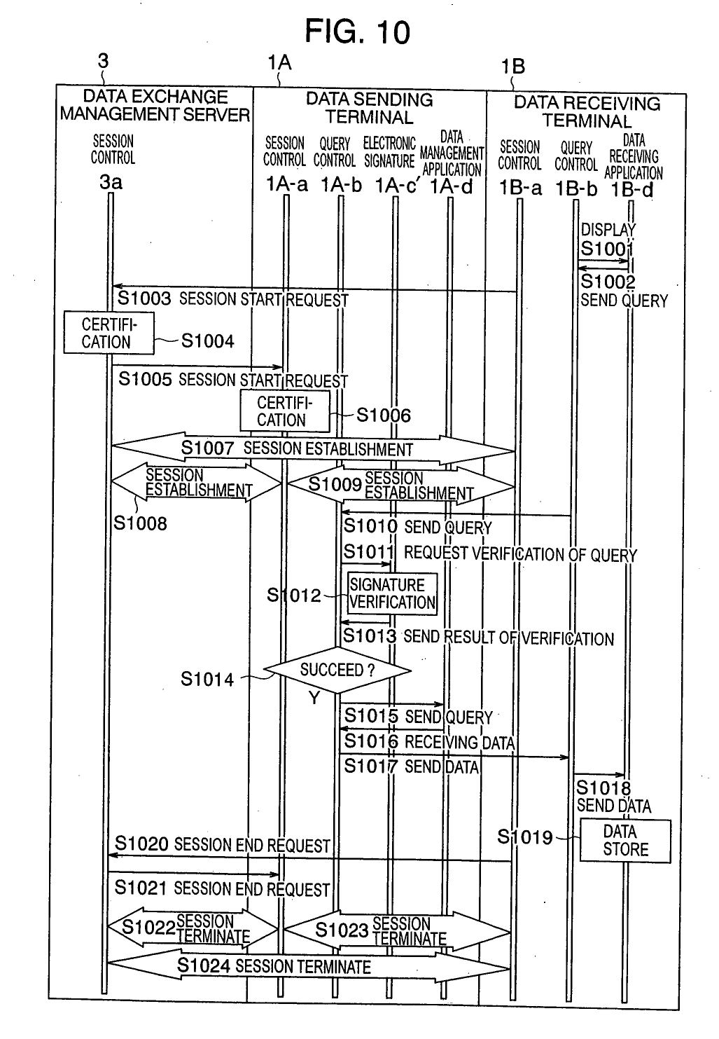

Next, a series of processing inclusive of “data request and retrieval” (portion indicated by dash line in FIG. 8) will be explained with reference to FIG. 10 and appropriately to FIG. 8. When viewed from the user of the receiving terminal, this processing corresponds to the part where the user logs in the application used for the business (here, data receive application 1B-d) to confirm whether or not the data addressed to the user exists from the list of the queries and the data receiving processing is executed when such data exists.

First, the session control portion 1B-a sends the signed query stored to the data receive application 1B-d and the data receive application 1B-d executes the screen display, not shown, display the query (S1001). As the user on the data reception side selects the data to be received from the list of the queries, the input device, not shown, sends the query to the query control portion 1B-b (S1002).

Subsequently, the session control portion 1B-a of the data receiving terminal 1B sends the session start request to the session control portion 3a of the data exchange management server 3 (S1003). The session control portion 3a executes the verification procedure such as user verification (S1004). When this verification proves successful, the session start request is sent to the session control portion 1A-a of the data sending terminal 1A on the basis of the data sending terminal data contained in the session start request of the step S1003 (S1005). The session control portion 1A-a executes the verification procedure such as user verification (S1006). When this verification proves successful, the session of the encryption communication paths of the three (data exchange management server 3, data sending terminal 1A, data receiving terminal 1B) are established (S1007 to S1009). Incidentally, the sequence of the steps S1001 to S1002 may be reversed by the steps of S1003 to S1006.

Next, the query control portion 1B-b of the data receiving terminal 1B sends the signed query to the query control portion 1A-b of the data sending terminal 1A as the data query request (S1010). The query control portion 1A-b requests verification of the signed query received to the electronic signature verification portion 1A-c′ (S1011). The electronic signature verification portion 1A-c′ verifies the signed query it receives (S1012) and sends the verification result to the query control portion 1A-b (S1013). It is thus possible to confirm whether or not the query generated by the data sending terminal is falsified.

Since the processing in which the query control portion 1A-b receives the data and sends the received data to the data receiving terminal 1B (S1014 to S1019) is the same as the processing of the steps S421 to S426 shown in FIG. 3, the explanation will be omitted. The subsequent processing of the steps S1020 to S1024 as the session end processing among the three is the same as the processing of the steps S427 to S431 shown in FIG. 4 and its explanation will be omitted.

The feature of this embodiment is as follows. Because the data exchange management server 3 executes only the session management processing relating to the encryption communication path, the load of the server can be reduced. The data receiving terminal 1B does not need to gain access to the data exchange management but can confirm the query sent.

### Third Embodiment

The third embodiment relates to the embodiment that uses a query control key sent through another path in addition to the first embodiment.

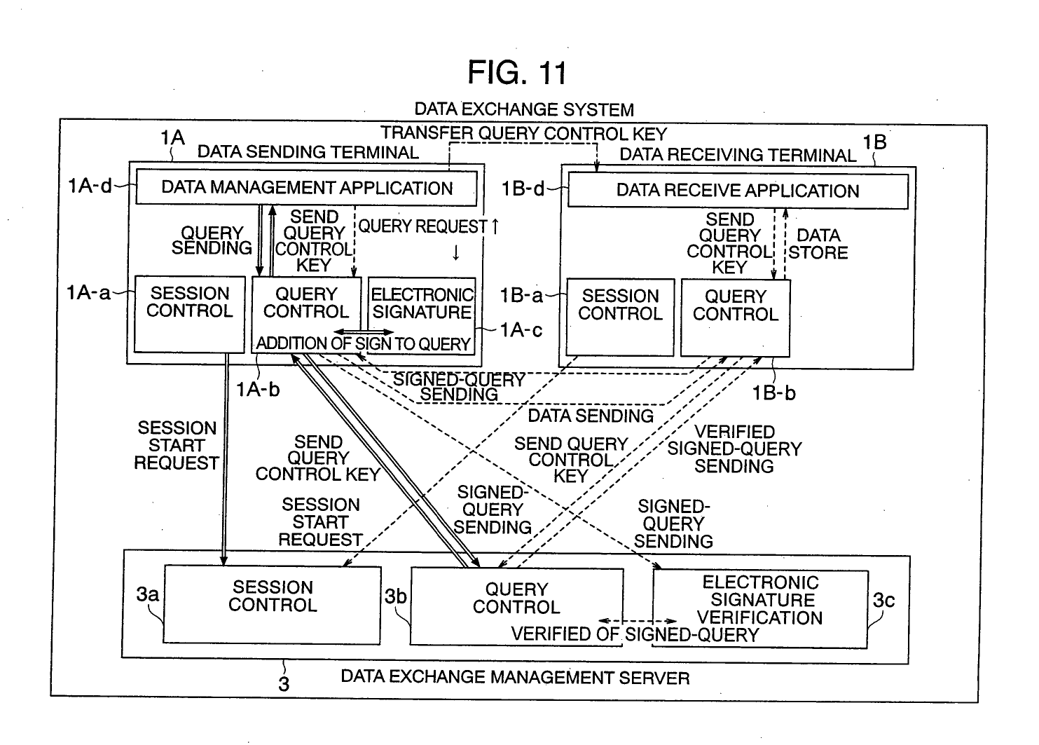

FIG. 11 is a view useful for explaining the outline of the data exchange system according to the third embodiment of the invention. In FIG. 11, the construction of the data exchange management system of this embodiment is the same in comparison with the construction of the first embodiment shown in FIG. 1 but the existence of the query control key is different.

In the data exchange method of this embodiment, the method of sending the data from the data sending terminal 1A to the data receiving terminal 1B is broadly divided into the following three kinds of processing.
(1) a series of processing inclusive of “sending of signed query” from the data sending terminal 1A to the data exchange management server 3 (indicated by double line);
(2) a processing of “sending of query control key” from the data sending terminal 1A to the data receiving terminal 1B (indicated by one-dot-chain line); and
(3) a processing of “data request and retrieval” from the data receiving terminal 1B to the data sending terminal 1A by utilizing the data exchange management server 3 (indicated by dash line).

The great difference of the processing from the first embodiment is that the data exchange management server 3 generates the query control key for extracting the query when it stores the query. The query control key may be a character string of alphabets or numeric figures, for example, as long as it can uniquely extract the query. It can also be represented by a bar code or a QR code. This query control key is sent from the data sending terminal 1A to the data receiving terminal 1B through sending means different from the network shown in FIG. 1 such as manual transportation, facsimile, mail, and so forth. Though the same physical network is used, sending means such as e-mail may be used, too. In the healthcare provision field, in particular, concealment can be improved by sending the query control key through the transportation by the stuff or the patient.

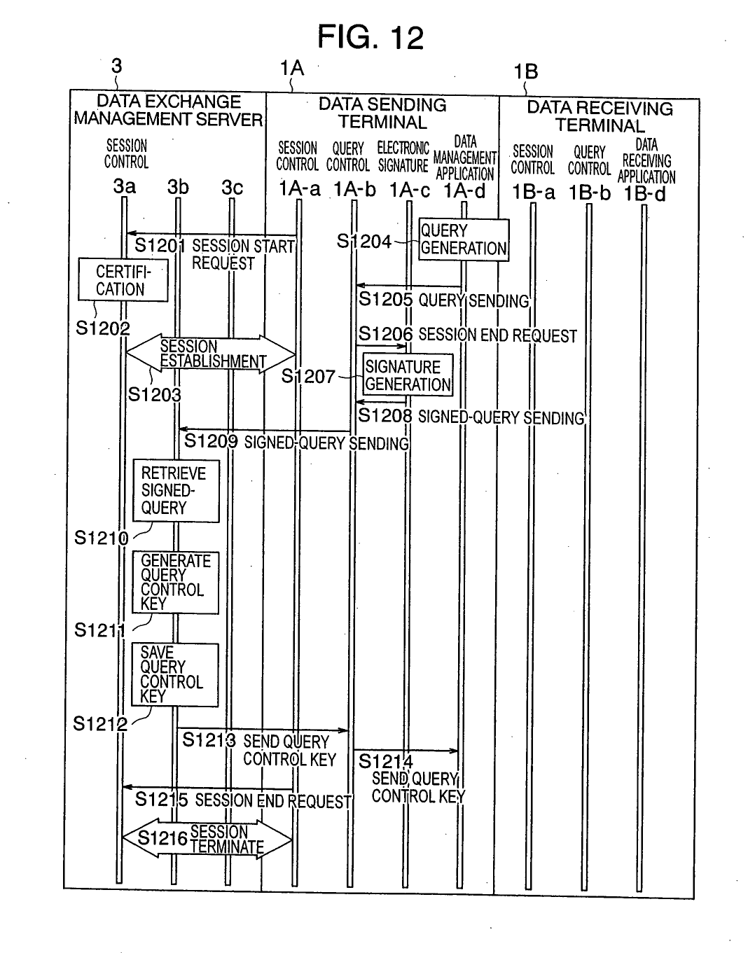

First, a series of processing inclusive of “sending of signed query” (portion indicated by double line in FIG. 11) will be explained with reference to FIG. 12 and appropriately to FIG. 11.

When viewed from the user of the sending terminal, this processing corresponds to the part where the processing for making login to the application used for the business (here, data management application 1A-d) to select a certain data, selecting the data receiving terminal and sending the data to the receiving terminal and the processing for generating (issuing) the query control key are executed.

The explanation of the steps S1201 to S1210 shown in FIG. 12 will be omitted because they are the same as the processing of the steps S301 to S310 explained in the first embodiment shown in FIG. 3.

The session between the data exchange management server 3 and the data sending terminal 1A is established by the processing described above. After the signed query is stored in the query control portion 3b of the data exchange management portion 3, the query control portion 3b generates the query control key on the basis of the signed query (S1211). This query control key is the key capable of primarily extracting the query as described above. The query control portion 3b stores the query control key so generated (S1212) and sends the query control key to the query control portion 1A-b of the data sending terminal 1A (S1213). The query control portion 1A-b sends the query control key received to the data management application 1A-d (S1214).

The explanation of the subsequent processing of the steps S1215 to S1216 for terminating the session between the two (data exchange management server 3 and data sending terminal 1A) will be omitted because it is the same as the processing of the steps S311 to S312 shown in FIG. 3.

After the step S1214, the data management application 1A-d outputs the query control key through the output device, not shown, and the query control key is sent by the user (patient, for example) to the data receiving terminal 1B through another path. This processing corresponds to “sending of query key” (portion indicated by one-dot-chain line) in FIG. 11.

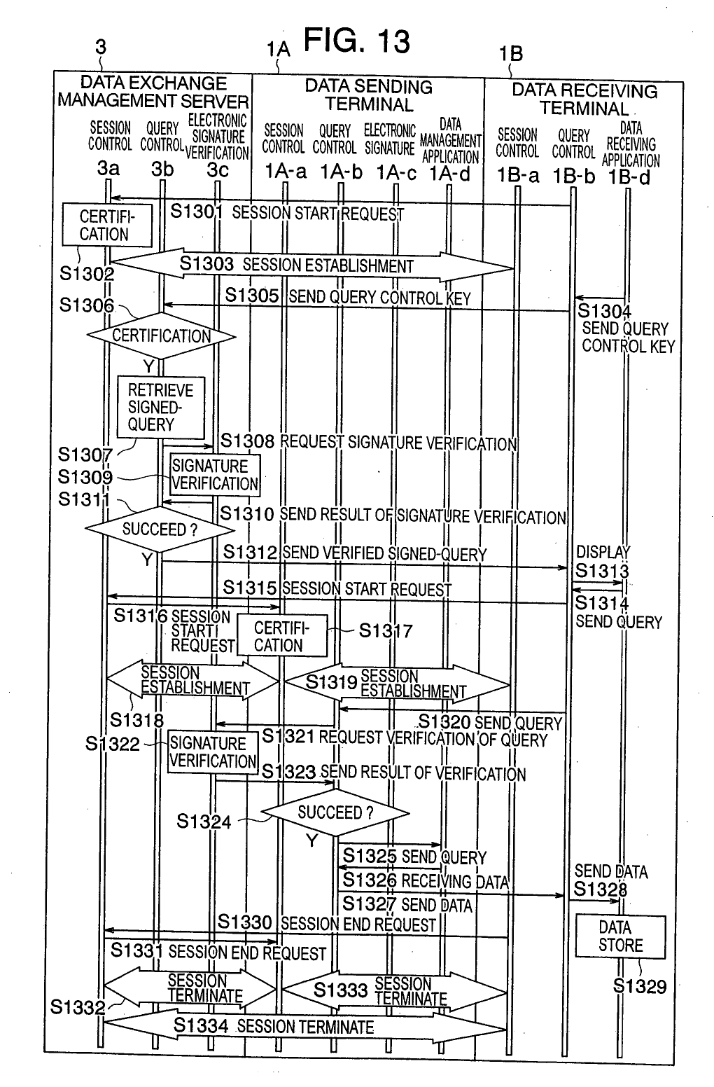

First, a series of processing inclusive of “data request and retrieval” (portion indicated by dash line in FIG. 11) will be explained with reference to FIG. 13 and appropriately to FIG. 11.

When viewed from the user of the receiving terminal, this processing corresponds to the part where the processing for making login to the application used for the business (here, data receive application 1B-d) to input the query control key sent, confirming whether or not the data address to its own exists and receiving the data, if any, is executed.

Steps S1301 to S1308 in FIG. 13 are the same as steps S401 to S408 explained in the first embodiment shown in FIG. 4 and their explanation will be therefore omitted.

When the session is established by this processing between the data exchange management server 3 and the data receiving terminal 1B, the data receiving application 1B-d of the data receiving terminal 1B subsequently inputs the query control key outputted in the step S1214 in FIG. 12 and sent through the input device not shown, and sends the query control key so received to the query control portion 1B-b (S1304). The query control portion 1B-b sends the query control key received to the query control portion 3b of the data exchange management server 3 (S1305). The query control portion 3b executes the verification procedure by comparing the query control key received with the query control key stored in the step S1212 shown in FIG. 12 (S1306). When the. result proves coincident (S1306→Y), the signed query information corresponding to the query control key is extracted (S1307). When the result is not coincident, on the other hand (S1306→N), the processing in the step S1307 is not executed and this non-coincidence is reported to the data receiving terminal 1B (not shown), whenever necessary. The explanation of the subsequent processing (Step 1308 to S1334) will be omitted because the processing is the same as the processing of the steps S405 to S431 explained in the first embodiment with reference to FIG. 4.

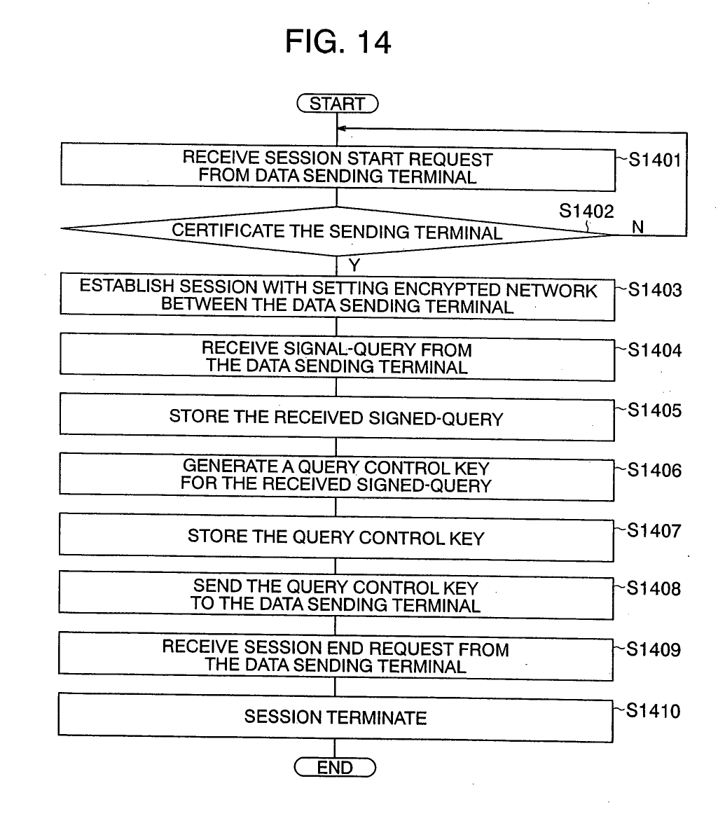

The processing of the data exchange management server 3 for generating the query control key will be explained with reference to FIG. 14 and appropriately to FIG. 12.

The explanation of the steps S1401 to S1410 shown in FIG. 14 will be omitted because they are the same as the processing of the steps S601 to S610 explained in the first embodiment shown in FIG. 6. The data exchange management server 3 that receives the signed query from the data sending terminal 1A by the processing described above generates the query control key from the signed query it receives (S1406) and stores the resulting query control key (S1407). The data exchange management server 3 sends the query control key so stored to the data sending terminal 1A (S1408). The session end processing of the subsequent steps S1409 to S1410 is the same as that of the steps S606 to S607 and the explanation will be omitted.

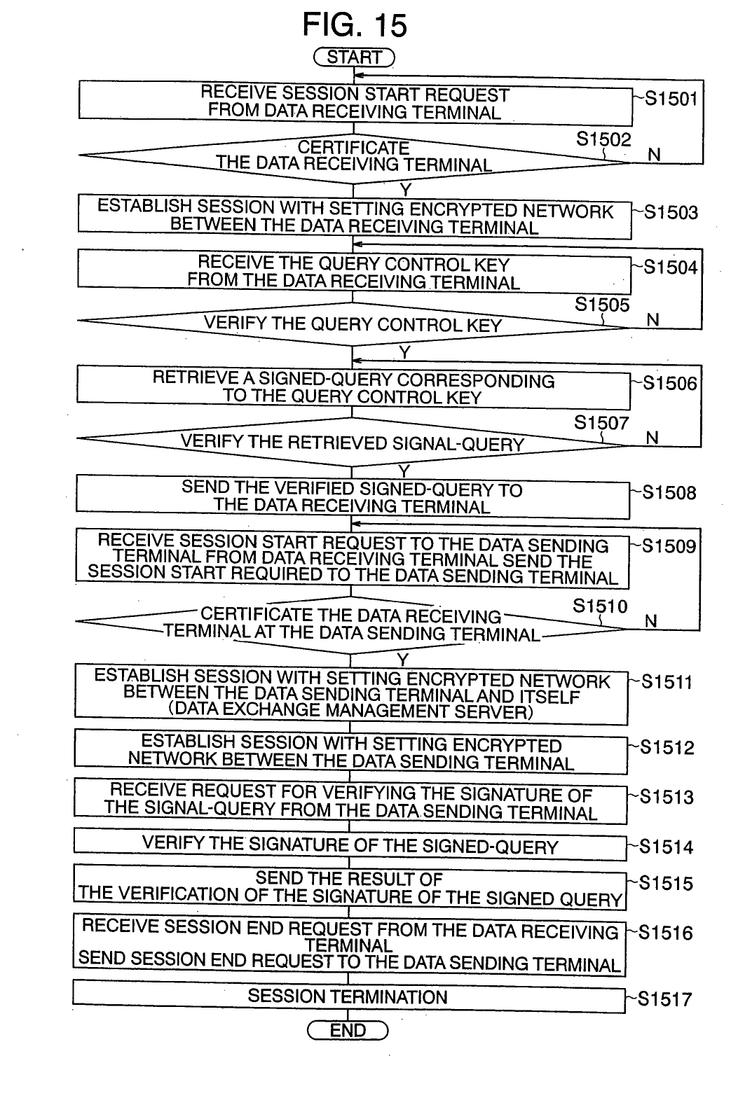

The processing of the data exchange management server 3 for generating the query control key will be explained with reference to FIG. 15 and appropriately to FIG. 13.

The explanation of the steps S1201 to S1210 shown in FIG. 12 will be omitted because they are the same as the processing of the steps S301 to S310 explained in the first embodiment shown in FIG. 3.

Since the session is established by the processing described above, the data exchange management portion 3 receives the query control key from the data receiving terminal (S1504) and executes the verification processing by collating that query control key with the query control key stored in the step S1407 shown in FIG. 14 (S1505). When the result proves coincident (S1505→Y), the signed query corresponding to the query control key is extracted (S1506). When the result is not coincident, on the other hand (S1505→N), the flow returns to the state before the step S1504.

The explanation of the subsequent processing of the steps S1507 to S1517 will be omitted because the processing is the same as the processing of the steps S705 to S715.

The features of this embodiment reside in that the data exchange management server 3 generates (issues) the query control key for extracting the signed query and the query control key sent to the data sending terminal 1A is sent through the different path to the data receiving terminal, and that the data exchange management server 3 executes verification and extraction of the signed query by using the query control key inputted by the data receiving terminal 1B.

In addition to the effect of the first embodiment, this embodiment can improve concealment of the data because the query control key is generated. In the case of the healthcare provision field, for example, the healthcare provider cannot receive the data unless the patient hands over the query control key to the healthcare provider when the form in which the patient transports the query control key is employed.

When articles and query control key are sent to the receiver and the receiver loads down the program for those articles which need incorporation of a program in the field of physical distribution, illegal retrieval of the program from the data sending terminal is difficult to execute as long as the query and the query control key exist. Even when the articles and the query control key are stolen, the program cannot be easily retrieved unless the query is available, and concealment can be improved. In this way, this embodiment can further improve concealment of the data.

Incidentally, the query control key is preferably the one that can uniquely extract the query but uniqueness is not always necessary. Since the query control key is not for examines whether or not the query can be retrieved, the query control key may be those which can secure concealment to a certain extent such as a keyword.

### Fourth Embodiment

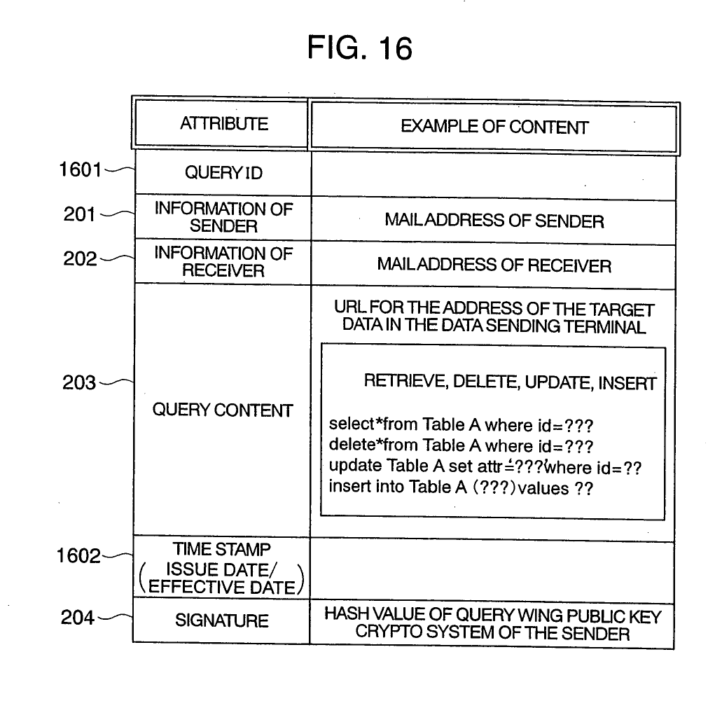

The fourth embodiment relates to the embodiment that devises two methods for improving concealment in addition to the confirmation of the query explained in the first embodiment. One of the methods is “ID allocation to query” and the second, “allocation of time stamp (issue date-hour/effective date) to query”. FIG. 16 shows an example of the data structure of the query. The difference from FIG. 2 representing the query of the first to third embodiments is that the query ID 1601 and the time stamp 1602 are added.

The query ID 1601 is put as the data sending terminal 1A sequentially allocates the number when generating the query, and is used for uniquely distinguishing the queries. In order to allow the use of the query only once such as for restricting the purchase of medicines that are originally critical when prescriptions are generated in the healthcare providers, for example, the data sending terminal 1A can set the limit to the number of times of usages of the corresponding query ID 1601. As to setting of the limit to the number of times of usages, there is the case where the user explicitly sets the limit or the case where the system side sets in advance depending on the kind of the data exchange. In the case of issuance of the prescription described above, for example, the number 1 may be automatically set to the limit to the number of times of usages whenever the business “issuance of prescription” is selected.

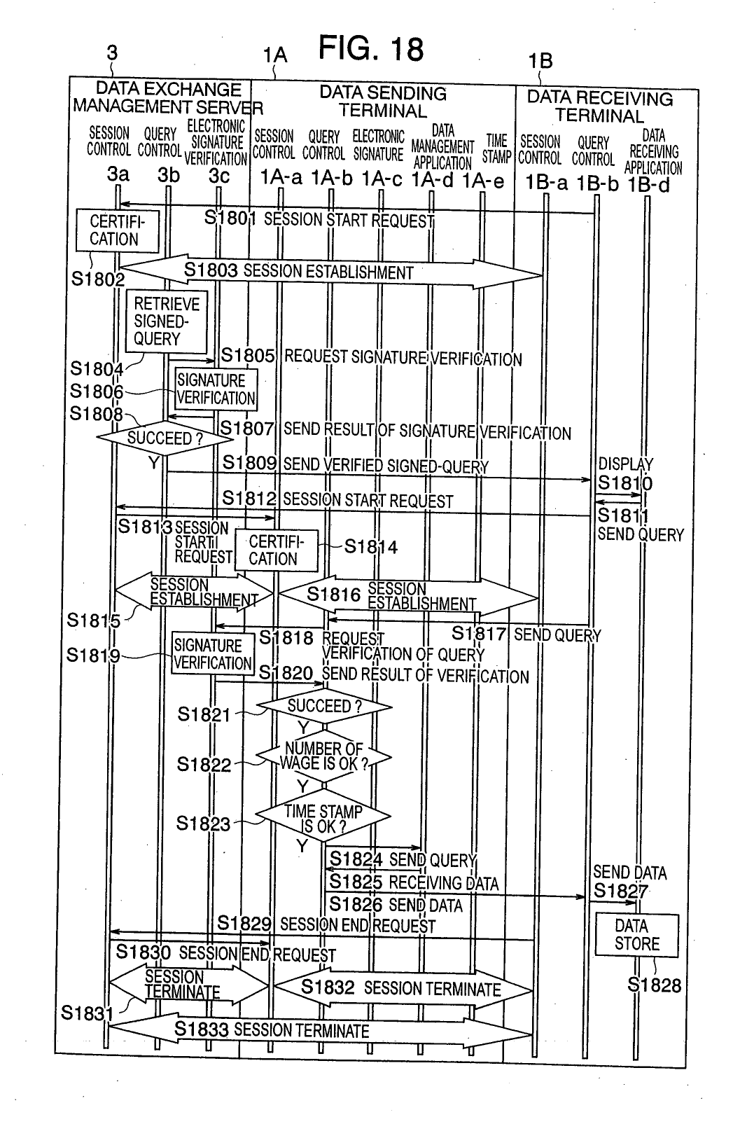

The processing of the query ID in this embodiment will be explained with reference to FIG. 18 showing a series of processing sequences inclusive of “data request and retrieval”. To achieve the processing for limiting the number of times of usages of the query ID, a count-up step of the number of times of usages of the query ID and a step which proves Y (S1822) only when the number of times of usages is within a limit number of times are added to Y after S1821, for example, and the data can be retrieved only when the number of times of usages is within the limit number of times.

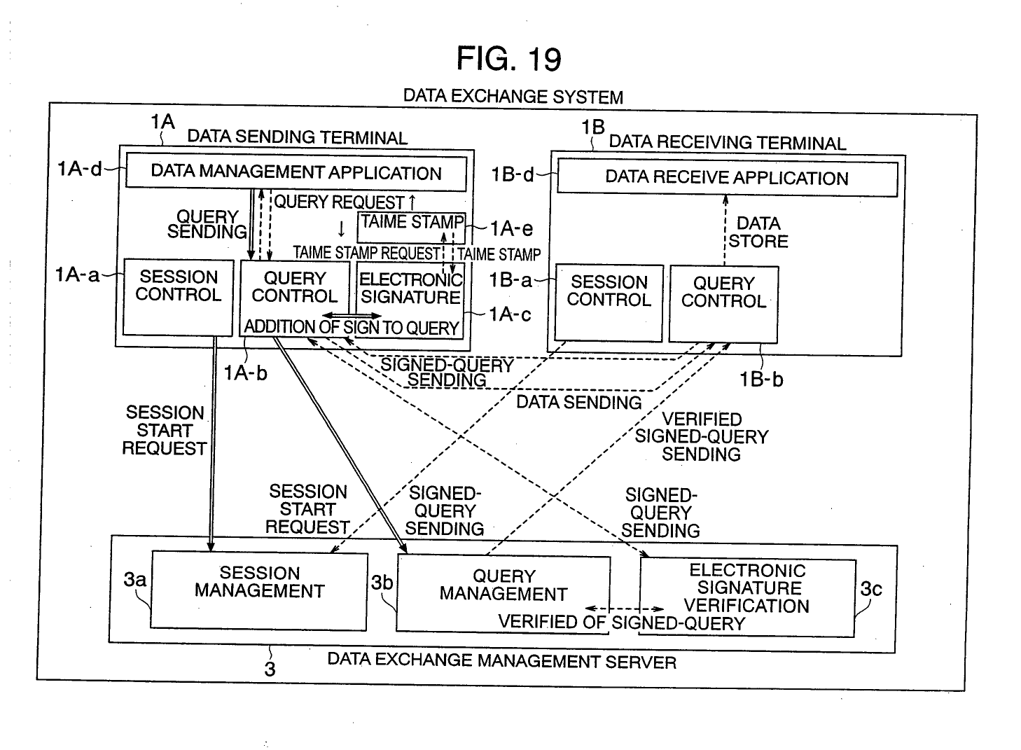

The time stamp 1602 representing the signature time and the effective date of the query is put by stamping a system time of the data sending terminal 1A or an external time stamp server. This is used for limiting the use of obsolete queries. FIG. 19 is a view for explaining the outline of this embodiment. In addition to the construction of the first embodiment (see FIG. 1), this embodiment has the time stamp portion at the data sending terminal 1A. Accordingly, it becomes possible to add the query containing the time stamp and its signature to the original document when the query is generated, and to prevent the data sending terminal from receiving the query after the passage of a predetermined time. Consequently, safety can be further improved.

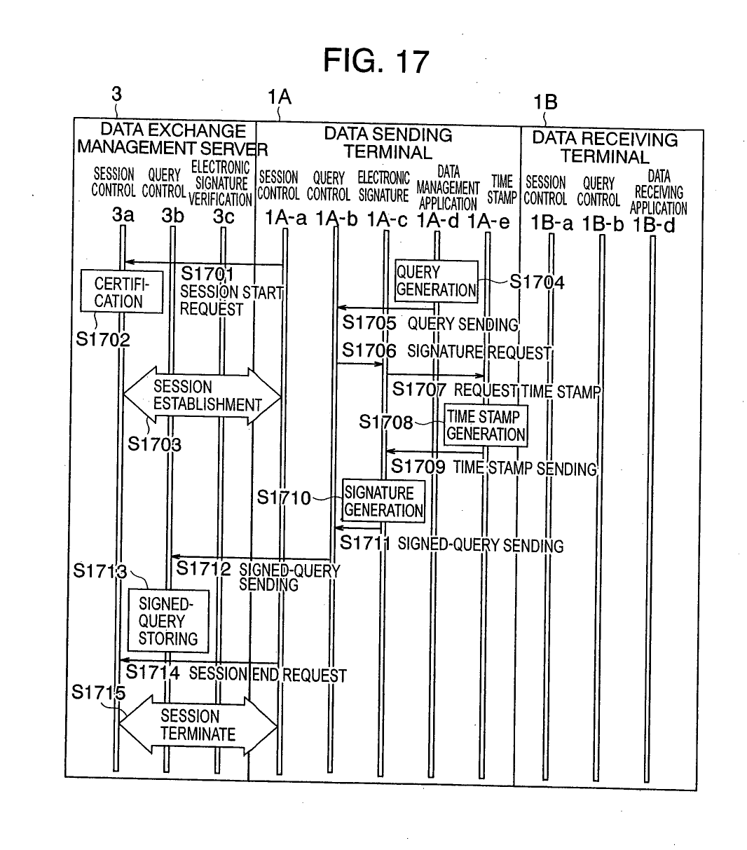

The processing for setting the time stamp in this embodiment will be explained with reference to FIG. 17 representing a series of processing sequence inclusive of “sending of signed query”.

The explanation of the steps S1701 to S1706 shown in FIG. 17 will be omitted because they are the same as the processing of the steps S301 to S306 explained in the first embodiment shown in FIG. 3.

The session between the data exchange management server 3 and the data sending terminal 1A is established by the processing described above. After the query is generated and the signature is requested, the electronic signature portion 1A-c of the data sending terminal 1A requests the time stamp to the time stamp portion 1A-e (S1707) and the time stamp portion 1A-e generates the time stamp (S1708) and sends the time stamp so generated to the electronic signature portion 1A-c (S1709).

As the time stamp confirmation processing at the time of retrieval of data, confirmation of the time stamp is executed after the confirmation of the number of times of usages of the query by the query control portion 1A-b in the step S1822 shown in FIG. 18 (S1823). When the issue time described on the time stamp is out of the limit range, data retrieval becomes impossible (not shown in the drawing). Incidentally, when the effective date is set to the time stamp 1602 in place of the issue date, it is necessary to only confirm that the effective date is at the back of the present time. When the term in which query is possible is decided as a predetermined term (one month, for example) from the issue date of the query, it is necessary to confirm by adding the set term to the issue date of the time stamp 1602 that the term is later than the present time. When it is desired to change the set term in accordance with the query, the term may be set for each query by using the query ID 1601. It becomes thus possible to use both query whose validity is lost within a short period and query whose validity remains for a long time. Both issue date and effective date may be used for the time stamp 1602.

The explanation of the subsequent steps S1824 to S1833 will be omitted because they are the same as the processing of the steps S422 to S431 explained in the first embodiment shown in FIG. 4.

<<Others>>

Modified embodiments of the data exchange system according to the invention will be described hereinafter.

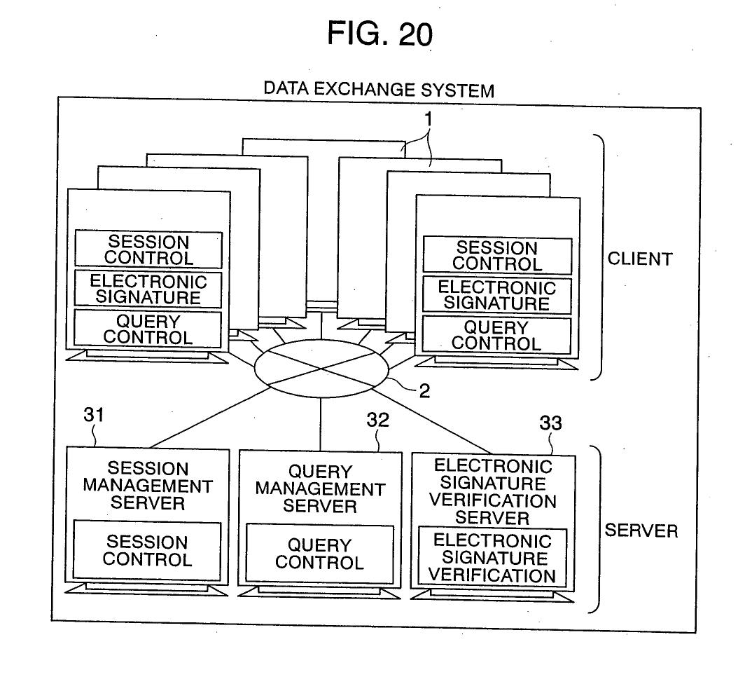

FIG. 20 shows a secrete data exchange system by constituting the session control portion 3a, the query control portion 3b and the electronic signature verification portion 3c constituting the first embodiment shown in FIG. 1 into independent servers, respectively.

The data exchange system shown in FIG. 20 includes a client side and a server side that are connected to each other through a network 2. The client side has a plurality of data sending and receiving terminals 1 (1A and 1B in FIG. 1) and the server side has a session management server 31 including the session control portion 3a, a query management server 32 including the query control portion 3b and an electronic signature verification server 33 including the electronic. signature verification portion 3c.

An encryption communication path is established between the data sending and receiving terminals by the session management server 31 and data is exchanged.

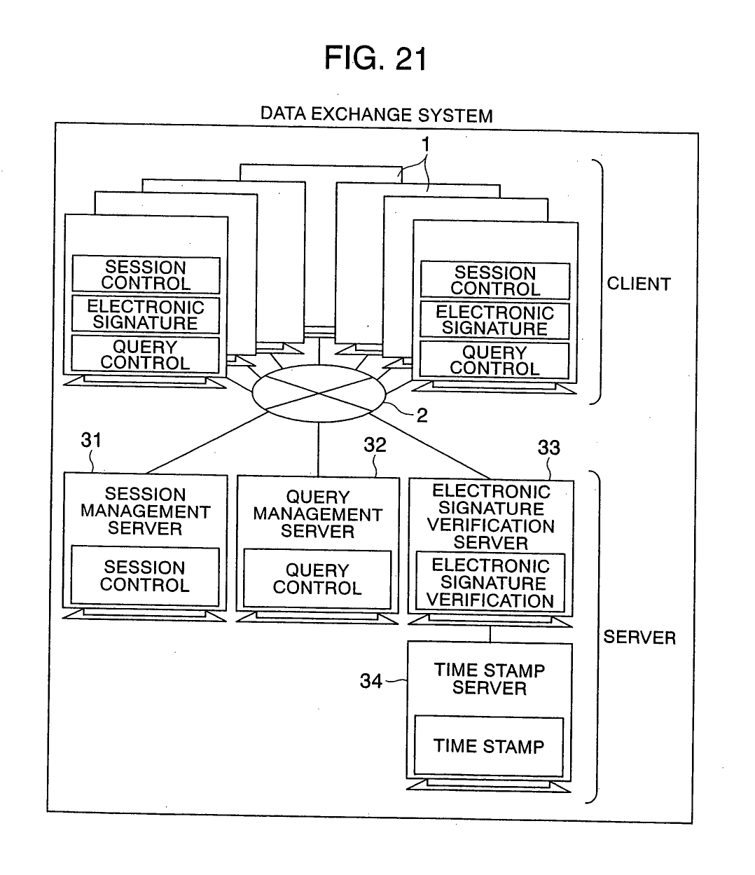

The network configuration shown in FIG. 21 can be used in the case of the fourth embodiment. In FIG. 21, a time stamp server 34 having a time stamp portion 3e is provided as an attachment to the electronic signature verification server 33.

The system can be constituted by using the construction shown in either FIG. 20 or FIG. 21 while data concealment and integrity are secured. Because the data is stored in the data sending and receiving terminals 1, the data can be stored in the dispersion system and the data center need not be constituted. Therefore, not only the data configuration but also the operation cost can be reduced.

When the data to be sent and received are stored in the centralized form in one of the specific terminals on the client side, centralized management of the data can be made by the method of the invention. As described above, the method of the invention has freedom such that it can select the distribution environment or the centralized management environment or their hybrid environment.

Incidentally, the address of the data sending terminal described in the query is the address of the specific terminal in this case. In other words, it is possible to accomplish the operation in which the address of the terminal sending the query and the address of the data sending terminal described in the query are different. This is effective not only for accomplishing the data center by the method of the invention but also for the case where the client and the server are constituted by different addresses in an information system such as an electronic clinic chart of a large scale.

In this embodiment, the user verification represents the verification between the terminal and the server or between the terminals but the user verification in the individual level can be made, too. In this case, the user is allowed to keep an IC card storing the individual identification information, for example, and a card reader is connected to the session control portion 1A-a of the data sending terminal 1A. When the IC card is loaded into the card reader for verification, the card reader reads the individual identification information of the IC card. The individual identification information thus read is sent to the session management portion 3a of the data exchange management server 3 through the session control portion 1A-a and the session management portion 3a executes the user verification on the basis of the individual identification information so received. Incidentally, a similar processing may be executed at the data receiving terminal 1B.

This method can further improve concealment as only a specific individual can peruse the information addressed to the specific individual.

To establish the encryption communication path in this embodiment, each of the constituent elements such as the data sending and receiving terminals (data sending terminal 1A and data receiving terminal 1B) and the data exchange management server 3 has the function of controlling the session but hardware such as an encryption communication path (VPN) can be installed in advance to each site. In this case, session establishment of the encryption communication path (VPN) is made in advance and overhead of each communication can be reduced.

When the encryption communication path is dynamically constituted without using this method, overhead can be reduced by conducting in bulk several communications or keeping the session until a certain period of time passes.

This embodiment is explained about the method that embeds the signature into the query but any method can be used as long as it can prevent forgery such as a method that embeds a random text into a text representing the query.

The construction in which the processing is executed among three constituents, i.e. data sending and receiving terminals and the data exchange management server 3 has been explained as the structural example of the invention but the processing may be executed among four or more members. The invention can further be modified within the scope of thereof.

Incidentally, the data sending and receiving terminals 1 (1A, 1B) as the constituent elements of the invention can be accomplished by the data management application (1A-d) and the data receiving application (1B-d) for executing the processing described above, respectively, and the programs of such applications can be provided while being stored in computer readable storage media (CD-ROM, etc). Such programs can be provided through the network 2, too.

The application of this method and the data exchange system to each industrial field will be explained.

The data management application portion and the data receiving application portion correspond to the electronic patient record system in the healthcare provision field. The diagnostic data prepared and collected by using the electronic patient record system can be safely exchanged beyond the medial institutions by using the method of the invention. For example, the diagnostic data include patient referral exchange among mhealthcare institutions, prescriptions from healthcare institutions to pharmacies, inspection data of laboratory centers and healthcare institutions, image data and radiological diagnosis reports among imaging centers, radiological diagnosis centers and healthcare institutions, clinical data of clinical experiments from healthcare institutions to pharmaceutical manufacturers, and so forth. These data can be exchanged while keeping concealment and integrity and both prevention of leak of individual information and improvement of business efficiency can be accomplished. In the financial field, asset information and buyout information can be safely sent. In the field of physical distribution, programs and the like can be safely sent by the method of the invention. Government and municipalities can safely send the information of residents. The invention can also be applied to questionnaire. In this case, an access method (query) to questionnaire but not questionnaire itself is sent to a plurality of data receiving terminals. The data receiving terminals input answers to each research data on the basis of the access method (query) sent. In ordinary questionnaires, participants can answer a plurality of answers but this method can distinguish the participants and can improve reliability of statistics of the questionnaire.

1. A data exchange method for exchanging data among a plurality of terminals and a data exchange management server for managing said plurality of terminals, connected to said plurality of terminals through a network, wherein:
a terminal operating as a data sending terminal among said plurality of terminals executes a step of generating a query for extracting data and encryption information for preventing falsification of said query;
said data exchange management server executes a step of receiving and storing said query and said encryption information from said data sending terminal and a step of verifying said encryption information; and
a terminal operating as a data receiving terminal among said plurality of terminals executes a step of receiving said query and said encryption information from said data exchange management server and a step of retrieving predetermined data from said data sending terminal on the basis of said query and said encryption information.

2. A data exchange method according to claim 1, wherein said data exchange management server executes a step of generating a query control key from said query and a step of sending said query control key to said data sending terminal;
said data sending terminal executes a step of receiving said query control key from said data exchange management server;
said data receiving terminal executes a step of sending said query control key sent to said data sending terminal and retrieved by a predetermined procedure to said data exchange management server; and
said data exchange management server executes a step of receiving said query control key from said data receiving terminal and a step of verifying said query control key received.

3. A data exchange method according to claim 1, wherein said data sending terminal executes a step of applying query ID and a time stamp to said query and a step of verifying said query ID and said time stamp.

4. A data exchange method for exchanging data among a plurality of terminals connected to one another through a network, wherein a terminal operating as a data sending terminal among said plurality of terminals executes a step of generating a query for extracting data and encryption information for preventing falsification of said query, a step of sending said query and said encryption information to a data terminal operating as a data receiving terminal and a step of verifying said encryption information; and
said data receiving terminal executes a step of retrieving and storing said query and said encryption information from said data sending terminal and a step of retrieving predetermined data from said data sending terminal on the basis of said query and said encryption information.

5. A data exchange management system used for a data exchange system for exchanging data among a plurality of terminals and a data exchange management server for controlling said plurality of terminals, connected to said plurality of terminals through a network, comprising:
a session management portion for establishing encryption communication paths among a data terminal operating as a data sending terminal and a data terminal operating as a date receiving terminal among said plurality of terminals and said data exchange server;
a query control portion for sending said query for extracting data from said data sending terminal and said encryption information for preventing falsification of said query to said data receiving terminal; and
an electronic signature verification portion for verifying said encryption information.

6. A data exchange management system according to claim 5, wherein said query control portion has the function of generating a query control key from said query and sending said query control key to said data sending terminal, the function of receiving said query control key sent from said data sending terminal and retrieved by said data receiving terminal in a predetermined procedure from said data receiving terminal and verifying said query control key, and the function of extracting said query and said encryption information corresponding to said query from said data receiving terminal.

7. A data exchange management program for causing said data exchange method according to claim 4 to be executed by a computer.

8. A data exchange management program for causing said data exchange method according to claim 1 to be executed by a computer.
